(19) United States
(12) Patent Application Publication
(10) Pub. No.: US 2025/0203037 A1
(43) Pub. Date: Jun. 19, 2025

(54) CONTEXT-AWARE OBJECT INTERACTION FOR VIDEO CONFERENCE STREAM COMPOSITING

(71) Applicant: Intel Corporation, Santa Clara, CA (US)

(72) Inventor: Sean J.W. Lawrence, Bangalore (IN)

(21) Appl. No.: 18/543,832

(22) Filed: Dec. 18, 2023

(51) Int. Cl. H04N 5/272; G06F 40/279

(52) U.S. Cl. CPC H04N 5/272; G06F 40/279

(57) ABSTRACT

Various aspects of context aware object interaction prediction and segmentation, including video stream segmentation of a virtual background during a video call, are discussed. An example method of segmentation includes: receiving video data that depicts a human user and an object in a scene; receiving context data from another other data source, which is related to an interaction of the human user with the object; analyzing the context data to determine a shape of the object and a type of the interaction of the human user with the object; and generating a video stream that includes a virtual background overlaid on the video data. The virtual background can be segmented based on at least one outline of the human user, and the virtual background can be further segmented based on the shape of the object and the type of the interaction of the human user with the object.

### BACKGROUND

Video conferencing software is commonly used for many types of calls and meetings. Video conferencing applications have introduced functionality to segment a user to remove/replace the background with a “virtual” preset or custom background during a video conference (such as a background of a generic room, or a blurred background). However, one of the problems with the virtual background feature is that it will often segment only an expected outline of a human user who is looking directly at the camera.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIGS. 1A to 1D illustrate video conferencing scenarios, according to various examples;

FIG. 2 illustrates a data flow of a user environment object identification for composite video streaming, according to an example;

FIG. 3 illustrates data processing for composite video stream generation, according to an example;

FIG. 4 illustrates a flowchart of multimodal analysis for object prediction, based on user interaction and selection for segmentation, according to an example;

FIG. 5 illustrates a flowchart of an example method for performing segmentation of a video conferencing stream, according to an example;

FIG. 6 is a block diagram illustrating a configuration of a computing system to operate video conferencing software, according to an example; and

FIG. 7 is a block diagram illustrating an example machine upon which any one or more of the techniques (e.g., methodologies) discussed herein may perform, according to an example.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

The following disclosure relates to segmentation and video processing techniques. These techniques may be integrated into a variety of software programs, including but not limited to client-based video conferencing software operated by client devices (e.g., personal computers and mobile devices). However, the techniques discussed herein may also be applied at or with server- or edge-based video processing services.

One of the problems with the virtual background feature included in many types of video conferencing software is that this feature is designed to segment only the outline of the human user. If the user needs to show or describe some object on video, then the segmentation algorithms used by the virtual background feature will not work on that object unless the object is brought in the region of and in front of the user.

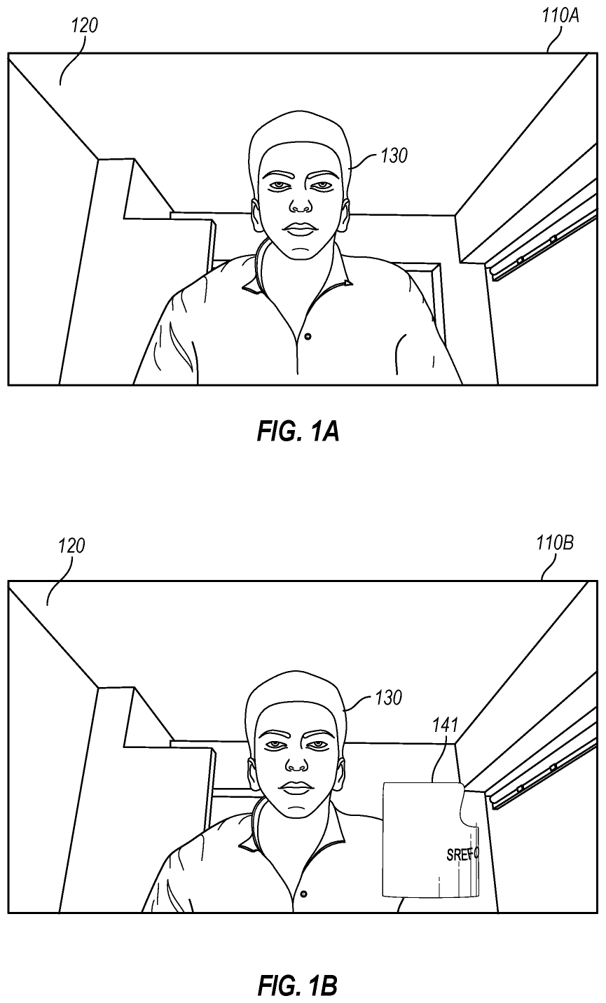

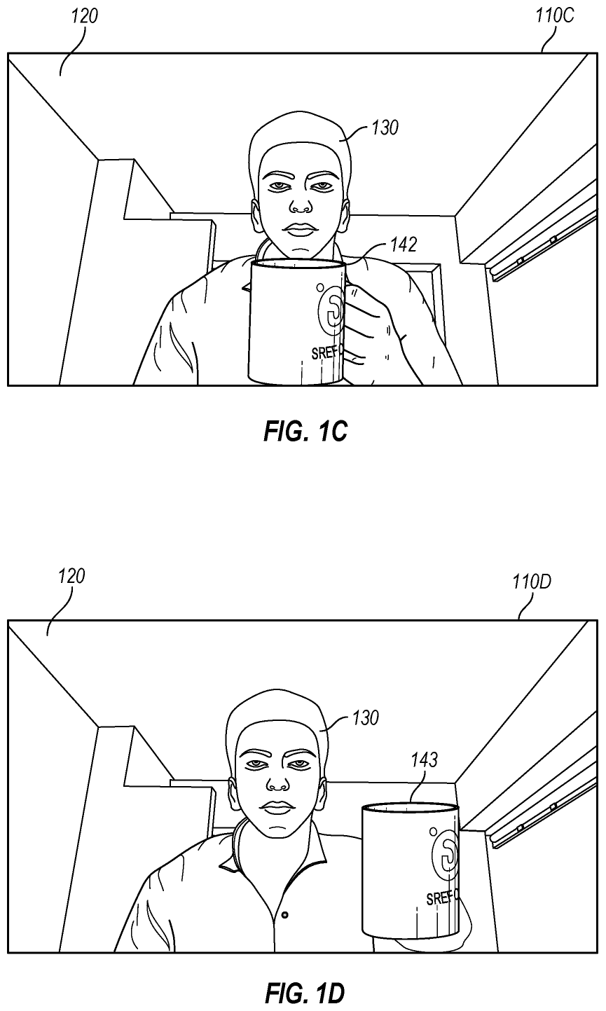

As an example of this scenario, FIG. 1A depicts a screenshot 110A of a video call, illustrating a human user 130 who is segmented to be visible within a virtual background 120. This virtual background 120 depicts a generic room, and the virtual background 120 is used to mask or hide the actual background in the environment of the human user 130.

Algorithms and models applied for this type of segmentation are typically trained to only segment the shape of human users. These algorithms and models are not tuned or trained to enable the presentation or interaction with other objects in the user's environment. As a result, when the user 130 desires to describe objects in the environment around the user 130 and stream the object as part of the conference video stream, the objects may be depicted with distortions. In other scenarios, the objects might not be depicted at all if the objects are determined to be part of the background environment.

FIG. 1B depicts a screenshot 110B of a video call, illustrating a scenario where the human user 130 begins to present an object (e.g., a coffee cup held in the user's hand). With conventional techniques for virtual background segmentation, the object will not be fully segmented and separated from the virtual background 120. This causes an incomplete shape 141 to be presented of the coffee cup, among other distorting effects of the video (e.g., only part of the user's hand or arm being visible).

FIG. 1C next depicts a screenshot 110C of a video call, illustrating a scenario where the human user 130 holds an object 142 (e.g., a coffee cup) in the foreground of the user. The object 142 is fully visible when held in front of the user's segmented outline. Accordingly, to depict an object with existing video call applications, a user may need to choose between: switching off the virtual background to reveal the actual background (which may not be desirable); or, moving the object to a location in front of the segmented user shape to show the object (as is illustrated in FIG. 1C). However, this workaround may not work in all situations. Moving the object in front of the user limits the size and type of objects available to be showcased, and the object must be held and interacted with in front of the user.

The following presents an improved approach to detect the interactive context of the user, to determine if objects in the scene should be segmented and added to (e.g., shown in) the video conferencing stream. In an example, all detected real-world objects in a video scene are identified and tracked. The interactive context of the user is determined from the various forms of inputs to the system (e.g., microphone, camera, keyboard, mouse, screen gestures, executed applications) to identify if one or more of the objects in the real world—other than the user—needs to be segmented and visible in the video. The interactive context of the user may be determined from the analysis of multi-modal (multiple modes, types, sources) of data, including visual data from the scene, language data from audio processing, gesture data from captured video, and device interaction data.

The following also discusses various approaches to evaluate or predict the interactive context of the user to modify the video conferencing segmentation and add other video processing operations, based on the analysis of multi-modal data. This includes the automatic prediction and identification of objects that correspond to the interactive context, and the monitoring and selection of objects from the user environment to be automatically included (or suggested for inclusion) in the composite video stream along with the user.

FIG. 1D depicts a screenshot 110D of a video call, illustrating a scenario where the human user 130 again holds an object 143 (e.g., a coffee cup). This video call is adapted to include composite video of the human user 130 and the object 143, based on segmentation controlled by a user's interactive context. As shown, this enables the object 143 to be held to the side of the user 130, outside of the user's outline, even as the object 143 is segmented correctly relative to the virtual background 120. This segmentation is enabled by identifying the interactive context of the human user 130, recognizing objects in the user's environment that may be interacted with. This segmentation is controlled by tracking a known shape of the object 143 within the virtual background 120 when this interaction is detected, and dynamically compositing the video stream as the object 143 is moved by the user 130 around the scene.

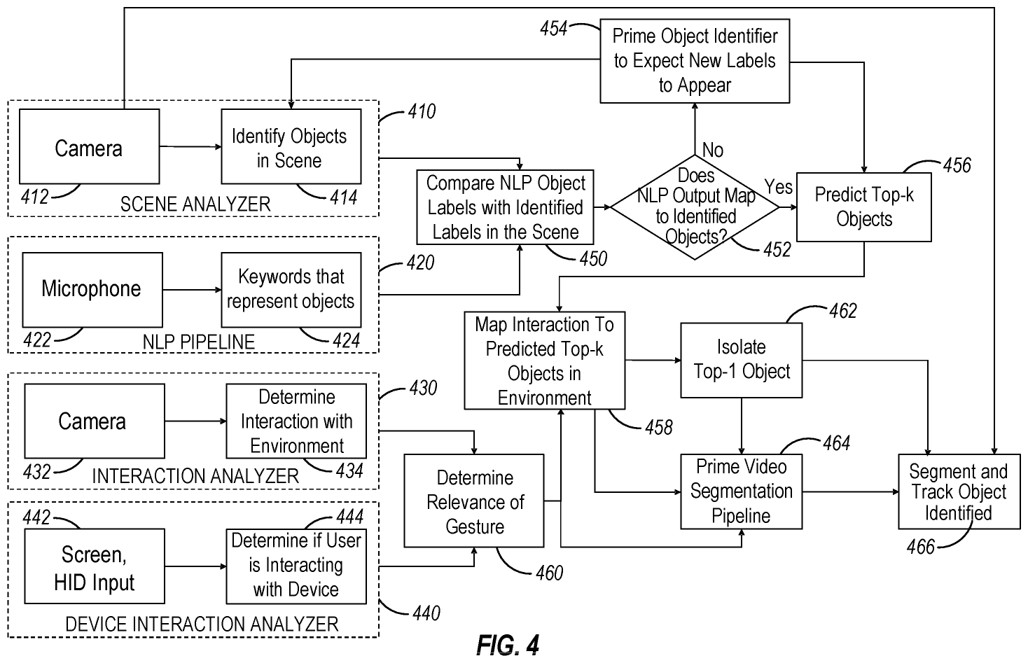

In an example, the identification of the interactive content and objects in the user's environment may include one or more of the following approaches. The combination of these approaches, including multi-modality data processing and video enhancements, is depicted in more detail in FIG. 4.

As a first example, an object is identified and tracked based on the detection of keywords that describe objects in the surrounding environment. In this example, microphone input produces audio data, and the audio data is processed with speech-to-text. Natural language processing (NLP) pipelines and keyword identification are then applied to the text to correlate discussions and context of one or more objects in the user's environment.

As a second example, a user action such as pointing to an object or picking up an object is identified and tracked. In this example, camera input produces video (e.g., image) data, and the video data (e.g., image(s)) is processed to detect one or more actions/gestures that are related to active user interaction with an object. If a user interaction with an object is identified, the object (e.g., a whiteboard) can be segmented in addition to an outline of the human user (e.g., the user's hand and arm pointing at the whiteboard).

As a third example, active user interactions with applications or images on the screen are tracked, and the user interactions are correlated with available actions or processes used in the computing device. Actions such as typing, moving a mouse, and touching a screen are identified and may be ignored for object tracking, as compared with other gestures and actions that interact with objects or related objects in the user's environment.

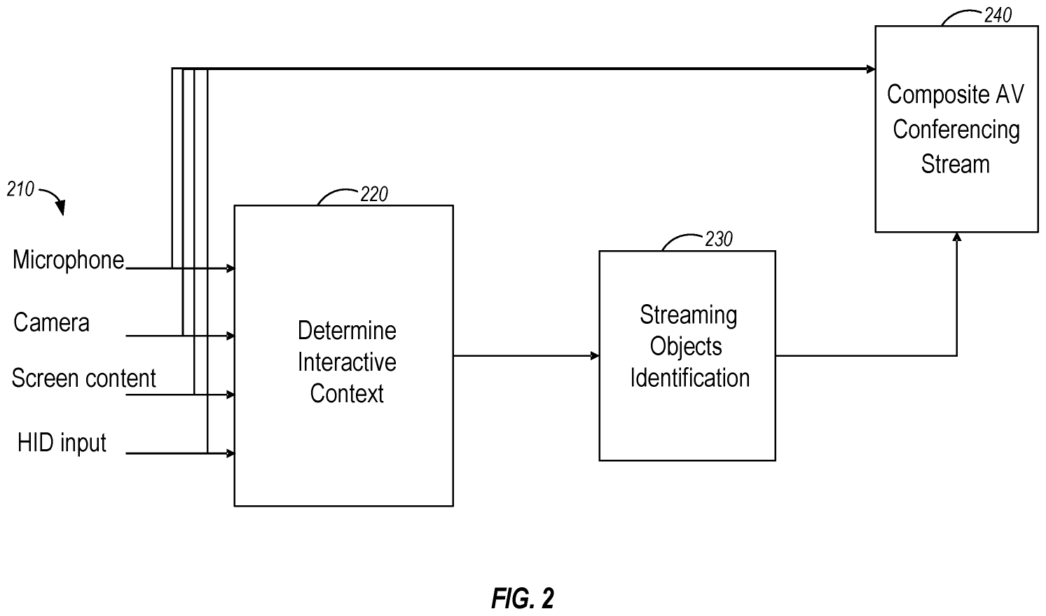

FIG. 2 illustrates a data flow for a user environment object identification for composite video streaming. This data flow depicts an evaluation of a pipeline/flow of data from multiple modalities to identify objects to be segmented and added to the composite video stream. Approaches for identifying and segmenting the outline of the human user are not shown, but may include any number of detection algorithms or processes.

As shown, the modalities 210 may include a microphone, camera, screen content, and/or a human-interface input device (e.g., mouse, keyboard, pointer, etc.). The data from the modalities 210 is provided to an analysis engine 220 to determine an interactive context of the user. This analysis engine 220 produces an identification of relevant objects 230 that are depicted or are predicted to be depicted in the video stream from the camera modality.

The video conferencing processing software combines data from the modalities 210 (e.g., microphone data, camera data) and a virtual background (e.g., an image or image library) to generate a composite audio/visual (AV) conferencing stream 240. This composite AV conferencing stream 240 is produced by applying a user segmentation algorithm to outline the shape of the human user(s) appearing in the video. Additionally, consistent with the techniques discussed herein, the composite AV conferencing stream 240 is produced or modified by applying an object segmentation algorithm to outline the shape of the object(s) appearing in the video. This enables the user and the object(s) to be simultaneously provided in the composite AV conferencing stream 240.

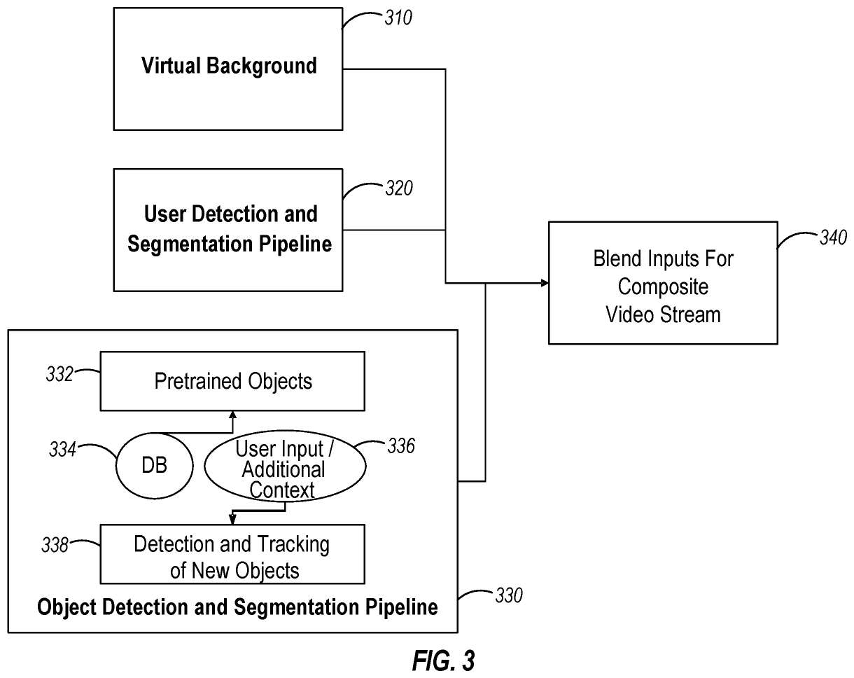

FIG. 3 illustrates a data processing flow for composite video stream generation. This data processing flow illustrates the different video sources of objects to the compositor (e.g., the engine or component that is used to produce the composite AV conferencing stream 240). Here, data inputs include the virtual background 310 and data from a user detection and segmentation pipeline 320. These data inputs are combined with data from an object detection and segmentation pipeline 330, and blended into a composite video stream 340.

The object detection and segmentation pipeline 330 may provide common shapes of pre-trained objects 332, based on a database 334 of available objects. The object detection and segmentation pipeline 330 may also include a mechanism 338 to detect and track new classes of objects. Labeling may be done via human input or using additional context 336.

In various examples, the pre-trained objects 332 may include shapes or characteristics of objects from common video conferencing environments such as office spaces, conference rooms, home offices, etc. This may include common objects such as office stationary, whiteboards, notebooks/paper with writing on it, etc., and other typical objects that human users may want to talk about formally or informally during a video conference.

The object detection and segmentation pipeline 330 may also provide functionality to learn objects in the user's environment, to improve segmentation for a particular user or use case. This functionality may include data from user input or additional context data 336, which results in the detection and tracking of new or custom objects 338. Unlabeled objects can be uploaded to a remote service, where inferences or classifications may be made using larger data processing models (e.g., available in the cloud service for multiple users).

Accordingly, a video segmentation mechanism may be improved to determine when an object should be segmented as well as determining contextual interaction with an environment in the video conferencing context. Additionally, the segmentation mechanism may be enhanced to predict objects that will be interacted with based on contextual analysis of multimodal input. This prediction may be used to prime the video processing pipelines for identification and segmentation of the object type/label, in cases when the object is not initially present, even before the object appears in a scene.

FIG. 4 illustrates a flowchart of multimodal analysis for object prediction for interaction and selection for segmentation. As shown, the context may be established using data produced from multiple modalities as follows.

A scene analyzer 410 performs a scene analysis on camera data (images) 412, to identify objects 414 present in the camera scene or in the environment.

An NLP pipeline 420 performs analysis on audio data 422 captured from a microphone and converts the audio data 422 into keywords 424 with speech-to-text processing. This analysis may include the identification and prediction of objects from the NLP pipeline 420 during user conversations, which may also assist the visual processing with identifying objects 414 in the camera data 412.

An interaction analyzer 430 performs gesture recognition and analysis on the camera data (video) 432, to determine interaction 434 with the object, a computing device, and/or other objects in the environment.

A device interaction analyzer 440 performs an evaluation of screen and input device data 442, to determine interaction 444 with the computing device (e.g., from a human interface device (HID) such as a mouse, keyboard, touchscreen). This analysis of the HID and screen input can be used to determine relevance of the gesture (at determination 460). The relevance determination can help identify if gestures or user actions are intended for control of the computing device, so that the interaction with some object (e.g., an input device) can be ignored or identified.

In FIG. 4, the multi-modal approach for data processing is used to establish the context for user interaction, so that the correct shape and timing can be applied for the segmentation of new objects introduced into the scene (or, applied to existing objects interacted with by the human user). In an example, the object labels detected from the scene analyzer 410 are compared with NLP-based object labels (keywords) (operation 450), to determine which NLP labels map to identified objects (evaluation 452). This is used to create a list of top-k predicted objects (operation 456). The top-k predicted objects are mapped to the output of the interaction analyzer 430 to determine if there is interaction with any of these objects (operation 458).

In an example, a visual object classifier is primed with the top-k list of objects that are expected to appear (operation 454). The segmentation and tracking pipeline is also primed (operation 464) based on the output of the interaction analyzer 430 and device interaction analyzer 440, such as to isolate the top-1 object (operation 462). Scene Analysis, NLP models, and object/reference identifiers may be trained with objects found in typical video conferencing environments.

Once an object is identified in the scene, the system waits for an opportunity for user interaction. For instance, consider a voice detection scenario, where the user has not yet interacted with an object but speaks the word “whiteboard.” This scenario would use the NLP pipeline 420 to determine that a keyword (label) in the scene may be invoked, with this keyword being mapped to an expected object or class of objects. The object can be selected from top-k objects, such as selecting a whiteboard from among a candidate wall, whiteboard, or poster objects in the room. When the user interaction is detected in the video data, the selected object is segmented and tracked (operation 466).

If there are additional interactions, and the user continues to point or gesture to the whiteboard, additional predictions and objects can be used to isolate what the top object or expected objects will be. Such predictions can be used to help the segmentation and the tracking of any movement or context switching among objects. Different models can be applied to detect and track object use scenarios, such as to apply a different set of object labels for office settings versus home settings. Such models may be trained based on typical objects used in a scene (in an office scenario, for example, using whiteboard, pens, markers, cups, etc.).

User interaction with the screen and an HID can be used to eliminate false positives of object detection, and to toggle the visualization of a particular object. For instance, suppose the user interacts with their computing device, such as by typing without intending to show their keyboard. This information on user input can be used to exclude a segmentation of the mouse or keyboard. Also consider a scenario where a user is talking about a whiteboard and pointing to the surface of the whiteboard. Upon a recognition of the context, the video may be segmented to show the content on the whiteboard. However, suppose that a user then moves a mouse, types, and/or touches the screen, or performs another computer interaction gesture. Depending on the context, the system could eliminate the segmentation of the whiteboard to remove the whiteboard from the scene (e.g., hiding the whiteboard with the virtual background).

Accordingly, the use of multiple modalities can be used to improve the confidence of segmentation, as well as eliminating incorrect or changing object segmentations. The use of data from multiple modalities can establish context with the object, and to more accurately determine the intent of the user to interact with the object. This may assist accuracy even if the interaction with the object is not detected on-camera. For instance, suppose a user speaks some phrase such as, “Let's raise a glass” before reaching for a glass cup to offer a toast. The camera has not yet identified any glass appearing in the video, but the system knows that a “glass” is a label of a known object, and this object may appear on camera soon. The system can be primed to expect objects and to apply segmentation on this object, so that once the glass does appear over the next few frames, segmentation can be performed on the object.

Priming a scene can include detecting objects that are in the scene and applying the segmentation algorithm based on a context of user interaction. This may include understanding that an object of a known label could become visible in the scene in a future video frame. Thus, in the example where the phrase “Let's raise a glass” is spoken, if the glass cup is not already in the scene, the glass will likely appear next to the user. The search area for the object can be limited to an area that is around or adjacent to the user (so that the object does not need to be searched in the entire video frame).

The present techniques may be combined with other environment modeling and detection techniques, including those that model an environment in three dimensions. Other aspects of video processing (pre- or post-processing) may include adjusting the focal length of a camera to better depict an object, person, or group of people, etc. This may improve video capture in large rooms, including when the camera is not able to identify or portray individual objects or capture detail on an object. A system may automatically (without user intervention) automatically and proactively analyze the objects based on the clarity, and change the sharpness, brightness, or contrast of the object image or video at different focal lengths. Thus, if a system knows that a whiteboard is located at a certain focal length, then when the user initiates or triggers the discussion of the whiteboard, the object can be segmented and the video camera settings can be changed to a suitable focal length to make the whiteboard readable.

In further scenarios, the human user and the object (e.g., a whiteboard) will need to be presented together, so the segmentation may be adapted to include the human user and the object within a single area. Additionally, other video processing may be performed to assist the presentation of a segmented whiteboard, such as when the user and another object are presented in a scene with different focal lengths. Other adjustments to frame rate, resolution, size, and other presentation aspects may be changed to better illustrate the user or individual objects.

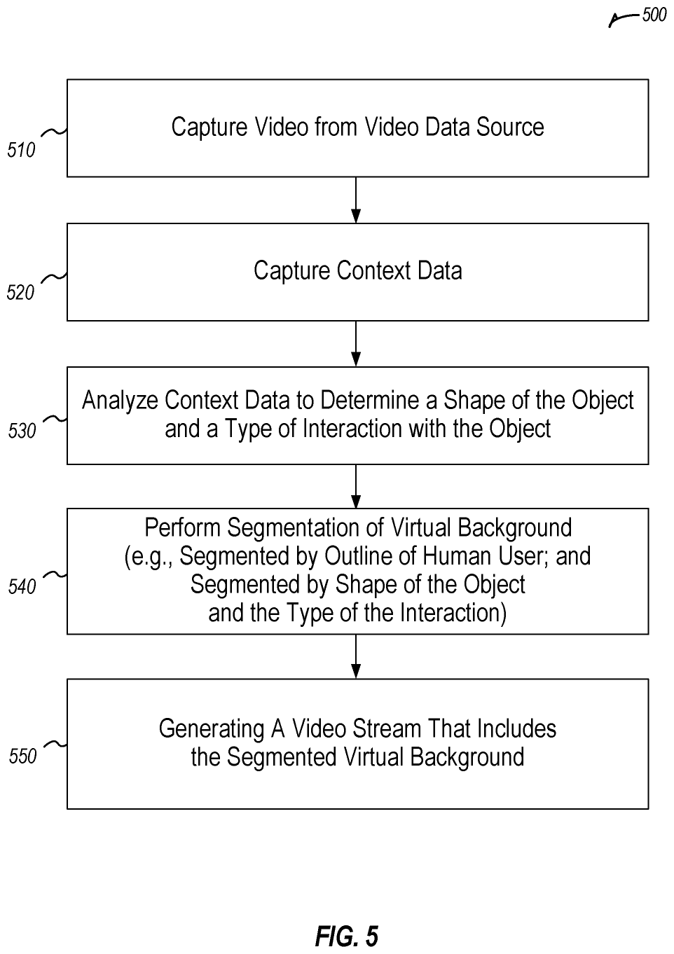

FIG. 5 illustrates a flowchart of an example method for performing segmentation of a video conferencing stream. The method may implement the operations discussed with reference to FIGS. 2, 3, and 4, discussed above, or a variation of such operations. In an example, the method may be implemented in a computing system including a memory device (e.g., storage memory such as non-volatile memory, or in volatile memory) that stores processing instructions and data, and processing circuitry (e.g., at least one processor) that executes processing instructions. In another example, the method may be implemented by at least one non-transitory machine-readable medium capable of storing instructions, where the instructions when executed by at least one processor cause the at least one processor to perform the method.

Operation 510 of the flowchart 500 includes capturing (or, selecting, obtaining, receiving, etc.) video data from a video data source. This video data includes one or more images or video frames that depict a human user and an object in a scene.

Operation 520 of the flowchart 500 includes capturing (or, selecting, obtaining, receiving, etc.) context data from at least one other data source (e.g., another modality). This context data provides data related to an interaction of the human user with the object. As an example, the context data may include audio data that captures speech from the human user. For instance, the video data may be captured from a camera of the computing device, and the audio data may be captured from a microphone of the computing device.

Operation 530 of the flowchart 500 includes analyzing the context data to determine a shape of the object and a type of the interaction of the human user with the object. In an example where the context data includes audio data, a speech-to-text conversion is performed on the audio data to produce text. Then, the shape of the object can be determined based on at least one keyword from the text. In a further example, analyzing the context data may include determining a plurality of candidate (potential) objects in the scene for interaction, and selecting the object from the plurality of candidate objects based on at least one other interaction performed by the human user (e.g., based on an interaction with the computing device related to the object).

Additionally or alternatively, the object may be selected and identified in the video data based on the at least one keyword. For instance, the shape of the object may be provided from a database of pre-trained objects, and the object may be selected from this database using the at least one keyword.

Additionally or alternatively, the analyzing of the context data may be performed based on identifying screen content that is output or otherwise provided on the computing device. For instance, the interaction of the human user with the object may be ignored or identified based on the screen content. Additionally or alternatively, the analyzing of the context data may be performed based on identifying a user input provided to the computing device. For instance, the user input may include at least one of a keyboard, mouse, touch, or gesture input from the human user, and the interaction of the human user with the object may be ignored or identified based on the user input.

Operation 540 of the flowchart 500 includes performing segmentation of video data, by segmenting a virtual background to enable the human user and the object to be visible (e.g., to remove the portions of the virtual background so that the human user and the object is visible). In an example, this segmentation causes the virtual background to be segmented based on at least one outline of the human user, and also causes the virtual background to be also segmented based on the shape of the object and the type of the interaction of the human user with the object.

Operation 550 of the flowchart 500 includes generating a video stream to include the segmented virtual background, overlaid on the video data. In further examples, additional video post-processing is performed on the video data based on the shape of the object and the type of the interaction of the human user. In still further examples, the video stream is output to be communicated (to another computing device, e.g., via a network connection) in a video call or video conferencing session.

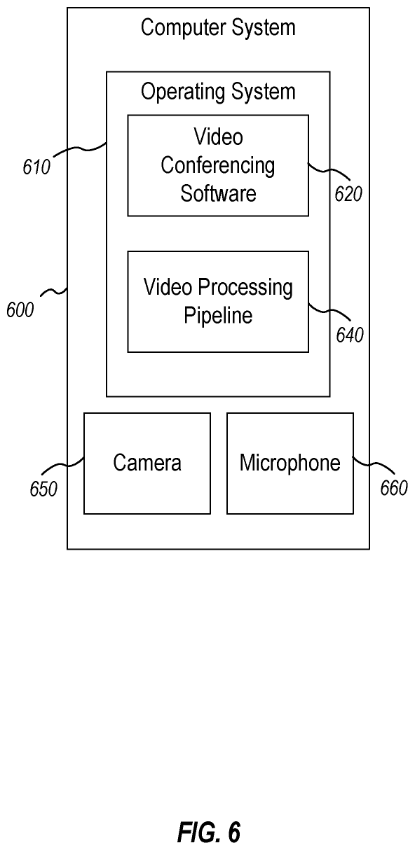

FIG. 6 is a block diagram illustrating a configuration of a computing system 600. As shown, the computing system 600 may include an operating system 610, video conferencing software 620, and video processing pipeline 640. The video data discussed herein may be provided by a camera 650 of the computing system; and the audio data discussed herein may be provided by a microphone 660 of the computing system.

Embodiments to implement the approaches above may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media (e.g., represented in portions of computing system 600 in FIG. 6, discussed below).

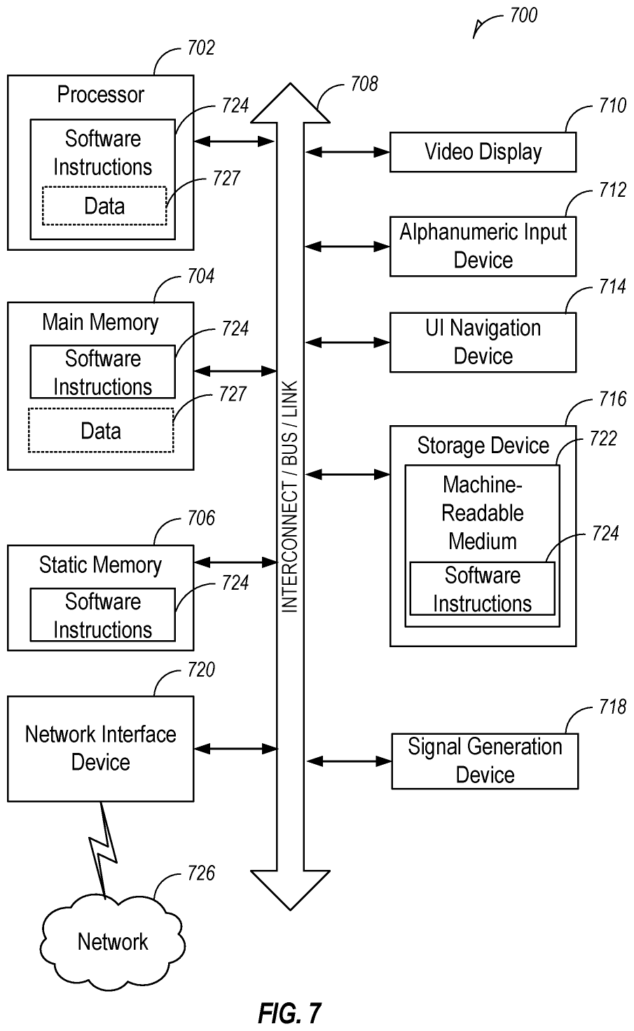

A processor subsystem (e.g., processor 702 in FIG. 7, discussed below) may be used to execute the instruction on the machine-readable medium. The processor subsystem may include one or more processors, with one or more cores in a respective processor. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Such components may be hardware, software, or firmware communicatively coupled to one or more processors in order to carry out the operations described herein. Components may be hardware components, and as such components may be considered tangible entities capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine-readable medium. In an example, the software, when executed by the underlying hardware of the component, causes the hardware to perform the specified operations. Accordingly, a hardware component is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, respective components need not be instantiated at any one moment in time. For example, where the components comprise a general-purpose hardware processor configured using software; the general-purpose hardware processor may be configured as respective different components at different times. Software may accordingly configure a hardware processor, for example, to constitute a particular component at one instance of time and to constitute a different component at a different instance of time. Components may also be software or firmware implementations, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or components may, collectively or individually, be embodied as circuitry that forms part of a larger system, for example, an integrated circuit (IC), system on-chip (SoC), desktop computers, laptop computers, tablet computers, servers, smart phones, etc.

As used in the present disclosure, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in the present disclosure, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture.

FIG. 7 is a block diagram illustrating a machine in the example form of a computer system 700, within which a set or sequence of instructions may be executed to cause the machine to perform any one of the methodologies discussed herein. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a vehicle subsystem, a personal computer (PC), a tablet PC, a hybrid tablet, a smartphone or other mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., interconnect or bus). The computer system 700 may further include a video display unit 710, an alphanumeric input device 712 (e.g., a keyboard), and a user interface (UI) navigation device 714 (e.g., a mouse). In one aspect, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, gyrometer, magnetometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media. As an example, the software instructions 724 may include instructions to implement and execute the segmentation operations via the processor (e.g., with software as configured and operated in the examples of FIG. 1D to FIG. 5). As a further example, the main memory 704 (or the other memory or storage) may host various data 727 used with the segmentation, audio or video processing, or context detection processing operations discussed herein.

While the machine-readable medium 722 is illustrated in an example aspect to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, 6G, DSRC, or satellite communication networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Additional examples of the presently described embodiments include the following, non-limiting implementations. Each of the following non-limiting examples may stand on its own or may be combined in any permutation or combination with any one or more of the other examples provided below or throughout the present disclosure.

Example 1 is a computing system configured to perform video segmentation and processing operations, comprising: a memory device to store received video data; and processing circuitry configured to: obtain or control the capture of video data from a video data source, the video data depicting a human user and an object in a scene; obtain or control the capture of context data from at least one other data source, the context data related to an interaction of the human user with the object; analyze the context data to determine a shape of the object and a type of the interaction of the human user with the object; and generate or produce an output of a video stream that includes a virtual background overlaid on the video data, the virtual background to be segmented based on at least one outline of the human user, and the virtual background to be further segmented based on the shape of the object and the type of the interaction of the human user with the object.

In Example 2, the subject matter of Example 1 optionally includes subject matter where the context data includes audio data with speech from the human user, and wherein the processing circuitry is further configured to: perform speech-to-text conversion of the audio data to produce text, wherein the shape of the object is determined based on at least one keyword from the text.

In Example 3, the subject matter of Example 2 optionally includes subject matter where the processing circuitry is further configured to: identify the object in the video data based on the at least one keyword from the text.

In Example 4, the subject matter of any one or more of Examples 2-3 optionally includes subject matter where the shape of the object is provided from a database of pre-trained objects, and wherein a selection of the object from the database is performed using the at least one keyword from the text.

In Example 5, the subject matter of any one or more of Examples 2-4 optionally include a camera to capture the video data; and a microphone to capture the audio data.

In Example 6, the subject matter of any one or more of Examples 1-5 optionally include a display device; wherein the processing circuitry is further configured to identify screen content output on the display device; and wherein the interaction of the human user with the object is ignored or identified based on the screen content.

In Example 7, the subject matter of any one or more of Examples 1-6 optionally include a user input device; wherein the processing circuitry is further configured to identify a user input provided to the user input device, wherein the user input includes at least one of a keyboard, mouse, touch, or gesture input from the human user; and wherein the interaction of the human user with the object is ignored or identified based on the user input.

In Example 8, the subject matter of any one or more of Examples 1-7 optionally include subject matter where the processing circuitry is further configured to: analyze the context data to determine a plurality of candidate objects in the scene for interaction; and select the object from the plurality of candidate objects based on at least one other interaction performed by the human user related to the object.

In Example 9, the subject matter of any one or more of Examples 1-8 optionally include subject matter where the processing circuitry is further configured to: perform video post-processing on the video data based on the shape of the object and the type of the interaction of the human user.

In Example 10, the subject matter of any one or more of Examples 1-9 optionally include communications circuitry to provide the video stream to another computing system in a video call or video conferencing session.

Example 11 is at least one non-transitory machine-readable medium capable of storing instructions for video segmentation with a virtual background, wherein the instructions when executed by at least one processor of a computing device, cause the at least one processor to: obtain video data from a video data source, the video data depicting a human user and an object in a scene; obtain context data from at least one other data source, the context data related to an interaction of the human user with the object; analyze the context data to determine a shape of the object and a type of the interaction of the human user with the object; and generate a video stream that includes a virtual background overlaid on the video data, the virtual background to be segmented based on at least one outline of the human user, and the virtual background to be further segmented based on the shape of the object and the type of the interaction of the human user with the object.

In Example 12, the subject matter of Example 11 optionally includes subject matter where the context data includes audio data with speech from the human user, and wherein the instructions further cause the at least one processor to: perform speech-to-text conversion of the audio data to produce text, wherein the shape of the object is determined based on at least one keyword from the text.

In Example 13, the subject matter of Example 12 optionally includes subject matter where the instructions further cause the at least one processor to: identify the object in the video data based on the at least one keyword from the text.

In Example 14, the subject matter of any one or more of Examples 12-13 optionally includes subject matter where the shape of the object is provided from a database of pre-trained objects, and wherein a selection of the object from the database is performed using the at least one keyword from the text.

In Example 15, the subject matter of any one or more of Examples 12-14 optionally include subject matter where the video data is captured from a camera of the computing device, and wherein the audio data is captured from a microphone of the computing device.

In Example 16, the subject matter of any one or more of Examples 11-15 optionally include subject matter where the instructions further cause the at least one processor to: identify screen content output on the computing device; wherein the interaction of the human user with the object is ignored or identified based on the screen content.

In Example 17, the subject matter of any one or more of Examples 11-16 optionally include subject matter where the instructions further cause the at least one processor to: identify a user input provided to the computing device, wherein the user input includes at least one of a keyboard, mouse, touch, or gesture input from the human user; wherein the interaction of the human user with the object is ignored or identified based on the user input.

In Example 18, the subject matter of any one or more of Examples 11-17 optionally include subject matter where the instructions further cause the at least one processor to: analyze the context data to determine a plurality of candidate objects in the scene for interaction; and select the object from the plurality of candidate objects based on at least one other interaction performed by the human user with the computing device related to the object.

In Example 19, the subject matter of any one or more of Examples 11-18 optionally include subject matter where the instructions further cause the at least one processor to: perform video post-processing on the video data based on the shape of the object and the type of the interaction of the human user.

In Example 20, the subject matter of any one or more of Examples 11-19 optionally include subject matter where the instructions further cause the at least one processor to: cause an output of the video stream, the video stream to be communicated in a video call or video conferencing session to another computing device.

Example 21 is a method for video segmentation with a virtual background, performed by a computing device, the method comprising: receiving video data from a video data source, the video data depicting a human user and an object in a scene; receiving context data from at least one other data source, the context data related to an interaction of the human user with the object; analyzing the context data to determine a shape of the object and a type of the interaction of the human user with the object; and generating a video stream that includes a virtual background overlaid on the video data, the virtual background to be segmented based on at least one outline of the human user, and the virtual background to be further segmented based on the shape of the object and the type of the interaction of the human user with the object.

In Example 22, the subject matter of Example 21 optionally includes subject matter where the context data includes audio data with speech from the human user, and the method further comprising: performing speech-to-text conversion of the audio data to produce text, wherein the shape of the object is determined based on at least one keyword from the text.

In Example 23, the subject matter of Example 22 optionally includes identifying the object in the video data based on the at least one keyword from the text.

In Example 24, the subject matter of any one or more of Examples 22-23 optionally includes subject matter where the shape of the object is provided from a database of pre-trained objects, and wherein a selection of the object from the database is performed using the at least one keyword from the text.

In Example 25, the subject matter of any one or more of Examples 22-24 optionally include subject matter where the video data is captured from a camera of the computing device, and wherein the audio data is captured from a microphone of the computing device.

In Example 26, the subject matter of any one or more of Examples 21-25 optionally include identifying screen content output on the computing device; wherein the interaction of the human user with the object is ignored or identified based on the screen content.

In Example 27, the subject matter of any one or more of Examples 21-26 optionally include identifying a user input provided to the computing device, wherein the user input includes at least one of a keyboard, mouse, touch, or gesture input from the human user; wherein the interaction of the human user with the object is ignored or identified based on the user input.

In Example 28, the subject matter of any one or more of Examples 21-27 optionally include analyzing the context data to determine a plurality of candidate objects in the scene for interaction; and selecting the object from the plurality of candidate objects based on at least one other interaction performed by the human user with the computing device related to the object.

In Example 29, the subject matter of any one or more of Examples 21-28 optionally include performing video post-processing on the video data based on the shape of the object and the type of the interaction of the human user.

In Example 30, the subject matter of any one or more of Examples 21-29 optionally include outputting the video stream, the video stream to be communicated in a video call or video conferencing session to another computing device.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate aspect. The scope of the embodiments disclosed herein is to be determined with reference to the appended claims, along with the full scope of equivalents to which such claims are entitled.

What is claimed is:

1. A computing system configured to perform video segmentation and processing operations, comprising:
a memory device to store received video data; and
processing circuitry configured to:
obtain video data from a video data source, the video data depicting a human user and an object in a scene;
obtain context data from at least one other data source, the context data related to an interaction of the human user with the object;
analyze the context data to determine a shape of the object and a type of the interaction of the human user with the object; and
generate a video stream that includes a virtual background overlaid on the video data, the virtual background to be segmented based on at least one outline of the human user, and the virtual background to be further segmented based on the shape of the object and the type of the interaction of the human user with the object.

2. The computing system of claim 1, wherein the context data includes audio data with speech from the human user, and wherein the processing circuitry is further configured to:
perform speech-to-text conversion of the audio data to produce text, wherein the shape of the object is determined based on at least one keyword from the text.

3. The computing system of claim 2, wherein the processing circuitry is further configured to:
identify the object in the video data based on the at least one keyword from the text.

4. The computing system of claim 2, wherein the shape of the object is provided from a database of pre-trained objects, and wherein a selection of the object from the database is performed using the at least one keyword from the text.

5. The computing system of claim 2, further comprising:
a camera to capture the video data; and
a microphone to capture the audio data.

6. The computing system of claim 1, further comprising a display device;
wherein the processing circuitry is further configured to identify screen content output on the display device; and
wherein the interaction of the human user with the object is ignored or identified based on the screen content.

7. The computing system of claim 1, further comprising a user input device;
wherein the processing circuitry is further configured to identify a user input provided to the user input device, wherein the user input includes at least one of a keyboard, mouse, touch, or gesture input from the human user; and
wherein the interaction of the human user with the object is ignored or identified based on the user input.

8. The computing system of claim 1, wherein the processing circuitry is further configured to:
analyze the context data to determine a plurality of candidate objects in the scene for interaction; and
select the object from the plurality of candidate objects based on at least one other interaction performed by the human user related to the object.

9. The computing system of claim 1, wherein the processing circuitry is further configured to:
perform video post-processing on the video data based on the shape of the object and the type of the interaction of the human user.

10. The computing system of claim 1, further comprising:
communications circuitry to provide the video stream to another computing system in a video call or video conferencing session.

11. At least one non-transitory machine-readable medium capable of storing instructions for video segmentation with a virtual background, wherein the instructions when executed by at least one processor of a computing device, cause the at least one processor to:
obtain video data from a video data source, the video data depicting a human user and an object in a scene;
obtain context data from at least one other data source, the context data related to an interaction of the human user with the object;
analyze the context data to determine a shape of the object and a type of the interaction of the human user with the object; and
generate a video stream that includes a virtual background overlaid on the video data, the virtual background to be segmented based on at least one outline of the human user, and the virtual background to be further segmented based on the shape of the object and the type of the interaction of the human user with the object.

12. The at least one non-transitory machine-readable medium of claim 11, wherein the context data includes audio data with speech from the human user, and wherein the instructions further cause the at least one processor to:
perform speech-to-text conversion of the audio data to produce text, wherein the shape of the object is determined based on at least one keyword from the text.

13. The at least one non-transitory machine-readable medium of claim 12, wherein the instructions further cause the at least one processor to:
identify the object in the video data based on the at least one keyword from the text.

14. The at least one non-transitory machine-readable medium of claim 12, wherein the shape of the object is provided from a database of pre-trained objects, and wherein a selection of the object from the database is performed using the at least one keyword from the text.

15. The at least one non-transitory machine-readable medium of claim 12, wherein the video data is captured from a camera of the computing device, and wherein the audio data is captured from a microphone of the computing device.

16. The at least one non-transitory machine-readable medium of claim 11, wherein the instructions further cause the at least one processor to:
identify screen content output on the computing device;
wherein the interaction of the human user with the object is ignored or identified based on the screen content.

17. The at least one non-transitory machine-readable medium of claim 11, wherein the instructions further cause the at least one processor to:
identify a user input provided to the computing device, wherein the user input includes at least one of a keyboard, mouse, touch, or gesture input from the human user;
wherein the interaction of the human user with the object is ignored or identified based on the user input.

18. The at least one non-transitory machine-readable medium of claim 11, wherein the instructions further cause the at least one processor to:
analyze the context data to determine a plurality of candidate objects in the scene for interaction; and
select the object from the plurality of candidate objects based on at least one other interaction performed by the human user with the computing device related to the object.

19. The at least one non-transitory machine-readable medium of claim 11, wherein the instructions further cause the at least one processor to:
perform video post-processing on the video data based on the shape of the object and the type of the interaction of the human user.

20. The at least one non-transitory machine-readable medium of claim 11, wherein the instructions further cause the at least one processor to:
cause an output of the video stream, the video stream to be communicated in a video call or video conferencing session to another computing device.
